(19) United States
(12) Patent Application Publication
(10) Pub. No.: US 2005/0145680 A1
(43) Pub. Date: Jul. 7, 2005

(54) Space heating radiator

(76) Inventor: Constantine Travassaros, Glyfada (GR)

Correspondence Address: Crockett & Crockett;Suite 400, 24012 Calle De La Plata, Laguna Hills, CA, 92653, US

(21) Appl. No.: 11/004,444

(22) Filed: Dec. 3, 2004

(30) Foreign Application Priority Data
Jan. 2, 2004 (GR) GR2004 0100001

(51) Int. Cl. B23K 31/02; F24H 3/00

(52) U.S. Cl. 228/183; 237/70; 165/128

(57) ABSTRACT

A space Heating Radiator that is made from copper tubes welded onto one or more panels of aluminum, by means of a laser welding. A laser beam is focused in the acute angle formed between the copper pipes and the side of the aluminum panel. The Copper tubes can have the form of a serpentine or a meander. The tubes can be shaped before the laser beam welding. The radiator can be provided with additional aluminum fins welded to the plate and suitably shaped, to increase the heat transfer.

The invention relates to space heating radiators, in particular to space heating radiators that comprise tubes and metal plates and heat with infrared radiation emission and with convection.

### BACKGROUND ART

Conventional radiators are usually formed by a pair of corrugated steel plates welded to one another. The steel plates are shaped so as to form water channels. In order to increase their capacity to transfer by convection, they often have steel fins welded on the surface panels where the water is flowing through.

In order to form the water channels, the use of two steel plates is required, with adequate thickness, the weight and the cost are therefore significant. The distances between the water channels and their cross-section are chosen such that the temperature of the radiator is uniform, thus ensuring the highest possible heat transmission for a given size of radiator. Because the thermal conductivity of steel is relatively low, the distance between the water channels should be small. The shape of the radiators is limited by the material and the manufacturing method.

Another type of radiator is formed of steel or copper tubes. The wall thickness of pipes is such that they can be shaped and welded. This leads to a relatively high weight in comparison to the obtained radiating surface. The appearance of this type of radiators limits their acceptance.

The use of aluminum improves the thermal conductivity but this material is usually not used to form water channels. The difficulty to form water channels limits the wide spread use of aluminum. If aluminum plating is used, the copper or steel water tubes are usually mechanically bonded to the plate. To maintain a good heat transfer it is necessary to have large tube surface in contact with the aluminum plate. The tube surface bonded in the aluminum does however not contribute to the heating.

Similar problems, even if the heat flow is from the plate to the water channel, are also faced in the solar energy absorber of solar thermal collectors. Ultrasonic welding is used here to attach the copper plate absorber to the copper pipes. This technology is however not suitable for welding of aluminum plates to copper tubes.

The development of pulse laser welding allows the welding of copper tubes onto a full size plate of aluminum. The welding is achieved with a laser beam that is focused in the acute angle formed between the copper pipes and the side of the absorber plate.

### DISCLOSURE OF THE INVENTION

On this background, it is an object of the present invention to provide a space heating radiator that overcomes the above mentioned drawbacks. This object is achieved in accordance with claim 1 by providing a space heating radiator comprising at least one copper or copper alloy tube for conveying a heat transport medium and one or more aluminum or aluminum alloy panels for heat transfer to the surrounding space via radiation and convection that are secured to the copper alloy tube by welds. Thus, an effective, easy to manufacture and esthetically pleasing radiator is provided.

Two or more radiators according of this type can be connected in series to form a high power radiator.

It is yet another object of the present invention to provide a method of producing a space heating radiator that overcomes the above mentioned drawbacks. This object is achieved in accordance with claim 8 by providing a method of producing a space heating radiator comprising the steps of providing at least one copper or copper alloy tube for the transport of the heating medium, providing at least one aluminum or aluminum alloy panel for heat transfer to the surrounding space via radiation and convection, temporarily securing said copper or copper alloy tube on one of the sides of said at least one aluminum or aluminum alloy panel, permanently securing said copper or copper alloy tube to one of the sides of said at least one aluminum or aluminum alloy panel by applying a laser beam that is focused in the acute angle formed between the copper or copper alloy tubing and the side of the aluminum or aluminum alloy panel.

Further objects, features, advantages and properties of the space heating radiator and method of producing a space heating radiator according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which

FIG. 1 illustrates a side view of a radiator according to a first embodiment,

FIG. 2 illustrates the welding step of an embodiment of the method of producing a radiator,

FIGS. 3a to 3d are different views of a radiator according to a second embodiment,

FIG. 4 illustrates the welding step of a radiator according to a third embodiment,

FIGS. 5a and 5b illustrate fins that may be added to the radiator,

FIGS. 6a and 6b are different views of a radiator according to a fourth embodiment,

FIG. 7 illustrates a side view of a radiator according to a fifth embodiment.

### DETAILED DESCRIPTION

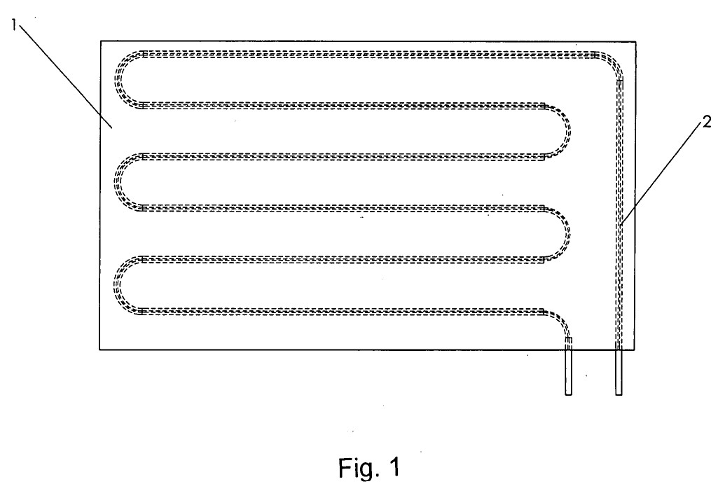

FIG. 1 illustrates an first embodiment of a radiator that comprises one tube 2 of suitable diameter to form a meander or serpentine conduit. The tube serves as a conduit for transporting the heating medium, which is usually hot water from a central heating system. A semi-hard copper tube with e.g. 10 mm diameter and wall thickness 0.4 mm, is de-coiled through a forming machine to obtain a meander shape. The distance between the parallel pipes is for example 100 mm. The copper tube ends are brazed with bronze fittings with e.g. ½ μl male thread, to be connected with a heating valve (not shown). The tube 2 can be made of different types of copper alloys such as Copper tube material Cu-DHP (CW024A).

An aluminum plate 1, e.g. 0.8 mm thick, painted white on the one side, with paint having high emissivity at infrared and covered by thin protective plastic foil, is cut in suitable dimensions. The sides of the plate 1 are formed so that there are no exposed sharp edges. The plate 1 can be made of different aluminum alloys such as Aluminum Alloy: AlMg 1.

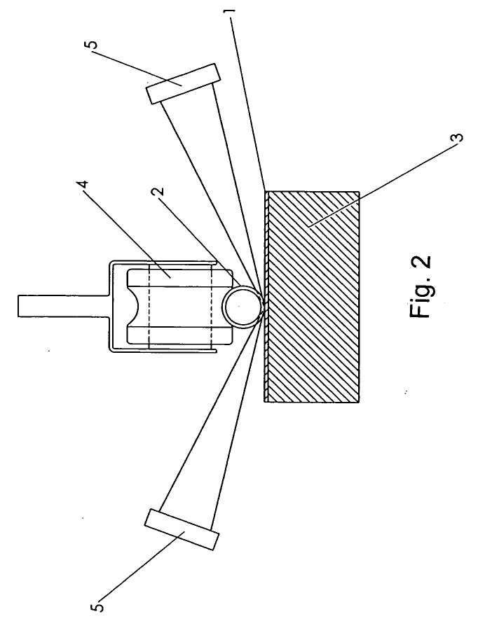

With reference to FIG. 2 the aluminum plate 1 is placed on horizontal flat table 3 with the painted surface facing the table. The water tube 2 is placed on the aluminum plate 1 and are temporarily fixed with mechanical clamps. FIG. 2 shows in section, the table 3 and the lower part of a suitable assembly 4 that presses from above on the pipe 2 to press the latter onto the aluminum plate 1. The pressure is local in the area of the welding, and the assembly 4 moves along the tube 2 as it is welded.

One or two pulse laser beams 5 are directed, transverse to the long axis of the pipe, in the acute recess that is formed between the pipe and the aluminum plate 1. The two reflective metals, the wavelength of beam, and the conical form of the recess, lead to the absorption of the energy of the beam resulting in the formation of a weld permanently connecting the tube to the plate. To increase the productivity, a second optical system directs simultaneously a laser beam on the opposite side of the copper tube. The welding speed can be more than 20 cm per second, depending on the capacity of the power source, the frequency of pulse and the distance between the welding spots.

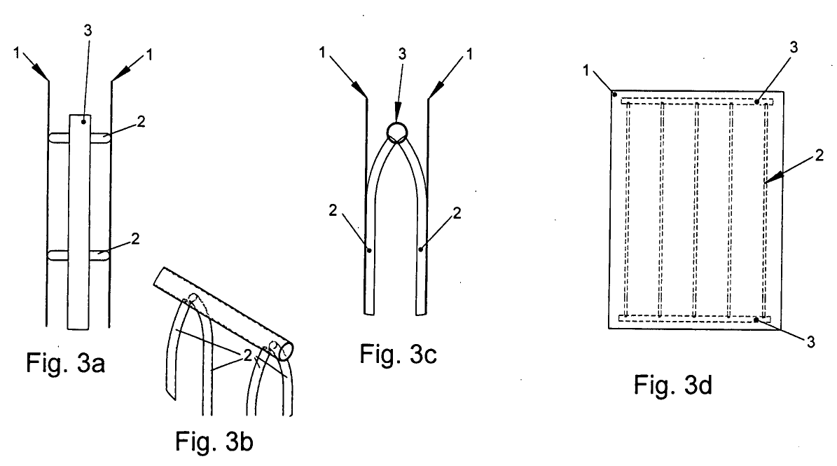

FIGS. 3a,3b,3c and 3d illustrate a radiator that is made from aluminum panels 1 welded onto tubes forming a serpentine conduit or flow path. The vertical pipes 2 have a smaller diameter than the horizontal header 3 which distributes the water in the vertical tubes.

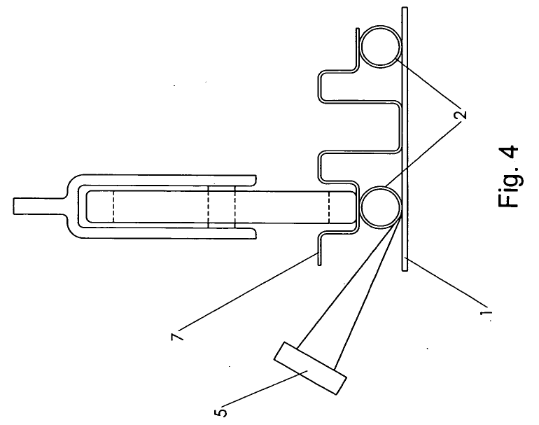

FIG. 4 illustrates a radiator with an aluminum plate 1 welded onto copper tubes 2. Additional shaped aluminum fins 7 formed by a corrugated sheet are welded onto the copper pipes. The aluminum fins are thinner than the plate 1 and have been welded on the copper pipes before the final configuration of the water channels, and increase the power of the radiator by increasing the surface heating the air.

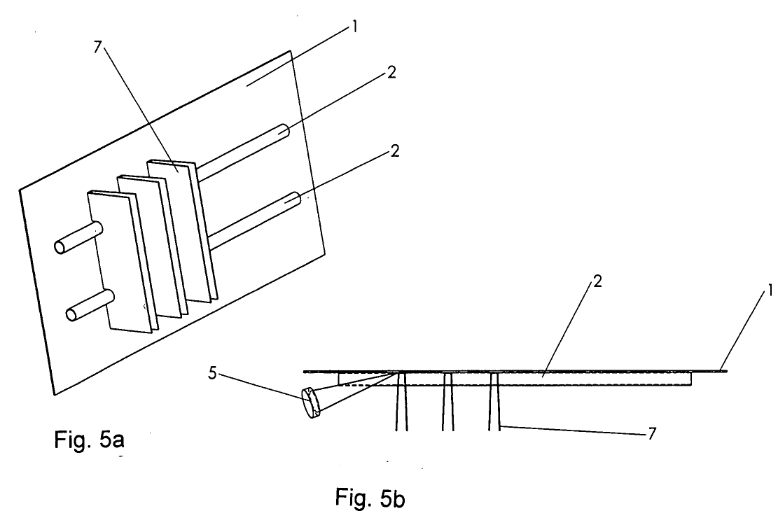

FIGS. 5a and 5b illustrate a radiator made of an aluminum plate 1 welded onto copper tubes 2 and aluminum fins 3 shaped and welded onto the aluminum plate and extending transversely thereto. FIG. 5b. also illustrates how the pulse laser is applied to weld the fins 7 to the plate 1.

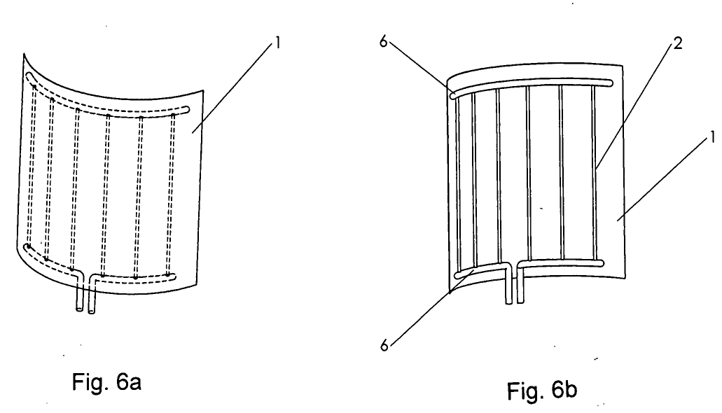

FIGS. 6a and 6b illustrate a relatively high radiator, for example 2 meters, with a curved form that is made from an aluminum plate 1 welded onto vertical copper tubes 2. The assembly of the tube and plate is then formed into its curved shape. The horizontal distribution pipes 6 are welded last.

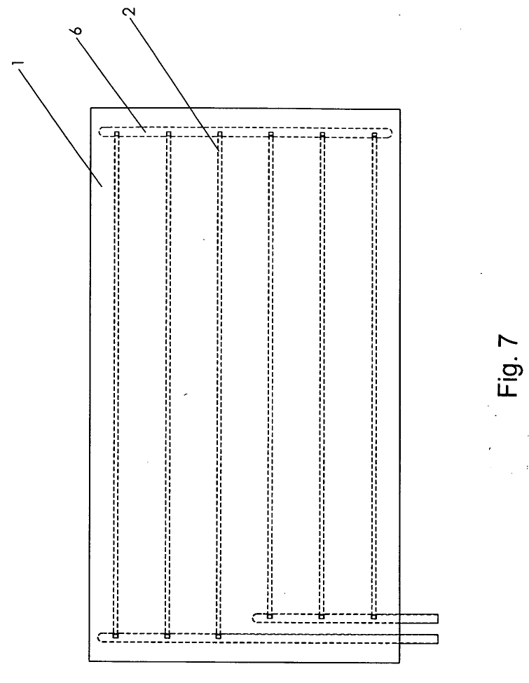

FIG. 7 illustrates radiator of long length with horizontally configured pipes 2, forming together with distribution pipes 6 a serpentine flow path with a hot water inlet and outlet on the same side.

Thus, while the preferred embodiments of the devices and methods have been described in reference to the environment in which they were developed, they are merely illustrative of the principles of the inventions. Other embodiments and configurations may be devised without departing from the scope of the appended claims.

1. A space heating radiator comprising at least one copper or copper alloy tube for conveying a heat transport medium and one or more aluminum or aluminum alloy panels for heat transfer to the surrounding space via radiation and convection that are secured to the copper alloy tube by welds.

2. A radiator according to claim 1, wherein the welds are laser beam welds.

3. A radiator according to the claim 1, wherein the tube has a serpentine form, said serpentine form preferably being created by an assembly of vertical tubes with horizontal tubes welded between them.

4. A radiator according to the claim 1, wherein the tube has the form of meandering conduit.

5. A radiator according to claim 1, further comprising aluminum fins secured to said tubes or to said panels by welds for increasing heat transfer by convection.

6. A radiator according to claim 5, wherein the welds securing the fins are laser welds.

7. An assembly of two or more radiators according to claim 1, connected in series to form a high power radiator.

8. A method of producing a space heating radiator, comprising the steps of:
providing at least one copper or copper alloy tube for the transport of the heating medium;
providing at least one aluminum or aluminum alloy panel for heat transfer to the surrounding space via radiation and convection;
temporarily securing said copper or copper alloy tube on one of the sides of said at least one aluminum or aluminum alloy panel;
permanently securing said copper or copper alloy tube to one of the sides of said at least one aluminum or aluminum alloy panel by applying a laser beam that is focused in the acute angle formed between the copper or copper alloy tubing and the side of the aluminum or aluminum alloy panel.

9. A method according to claim 8, wherein two laser beams are applied simultaneously on opposite sides of the tube.

10. A method according to claim 8, wherein the laser beam is a pulsed laser.

11. A method according to claim 8, in which the tube or tubes are be shaped before the step of permanently securing the tube to the plate.

12. A method according to claim 8, in which the tube is permanently secured to the panel by a series of welding spots.

13. A method according claim 8, further comprising the step of providing the final surface treatment to the panel before the welding step.
